(19) United States
(12) Patent Application Publication
(10) Pub. No.: US 2023/0214688 A1
(43) Pub. Date: Jul. 6, 2023

(54) Method, Apparatus for Determining Answer to Question, Device, Storage Medium and Program Product

(71) Applicant: Beijing Baidu Netcom Science Technology Co., Ltd., Beijing (CN)

(72) Inventors: Jiyuan ZHANG, Beijing (CN); Jianguo MAO, Beijing (CN); Zengfeng ZENG, Beijing (CN); Weihua PENG, Beijing (CN); Wenbin JIANG, Beijing (CN); Yajuan LYU, Beijing (CN)

(21) Appl. No.: 18/119,494

(22) Filed: Mar. 9, 2023

(30) Foreign Application Priority Data
Sep. 27, 2022 (CN) 202211182795.3

(51) Int. Cl. G06N 5/04

(52) U.S. Cl. CPC G06N 5/04

(57) ABSTRACT

A method and apparatus for determining an answer to a question are provided. The method includes: splicing an acquired to-be-queried question with each candidate answer into each question-answer pair; performing reasoning operations of feature combination parameters on different granularity features of each question-answer pair at a preset number of steps in a horizontal direction based on recurrent characteristics of a recurrent neural network; determining feature combination weights of the different granularity features using multiple preset vertical reasoning layers at different reasoning focuses respectively, at each step of the reasoning operations in the horizontal direction; obtaining a candidate answer feature corresponding to each question-answer pair, respectively, through a final step of the reasoning operations; and determining a target candidate answer matching the to-be-queried question based on a feature similarity between a question feature of the to-be-queried question and each candidate answer feature.

### CROSS-REFERENCE TO RELATED APPLICATIONS

The present application claims the priority of Chinese Patent Application No. 202211182795.3, titled “METHOD, APPARATUS FOR DETERMINING ANSWER TO QUESTION, DEVICE, STORAGE MEDIUM AND PROGRAM PRODUCT”, filed on Sep. 27, 2022, the content of which is incorporated herein by reference in its entirety.

### TECHNICAL FIELD

The present disclosure relates to the field of data technology, in particular to the technical field of artificial intelligence such as deep learning, natural language processing, and semantic recognition, which may be applied to knowledge Q&A and smart city scenarios, and more particularly, to a method and apparatus for determining an answer to a question, an electronic device, a computer readable storage medium, and a computer program product.

### BACKGROUND

Machine reading comprehension is a classic natural language processing task that is often used to test an intelligence level of a system. Benefiting from the development of technologies such as large-scale pre-trained language models, intelligent systems have surpassed an average level of humans in a question-answering ability on general-purpose domains.

Compared to the improvement of the question-answering ability on general-purpose domains, the question-answering ability provided by pre-trained language models is still significantly weaker than the average level of humans on further specialized domains (e.g., physics research, medical knowledge, etc.).

Therefore, how to enable the pre-trained language models to provide a higher question-answering ability for more complex questions on specialized domains is a pressing problem to be solved for those skilled in the art.

### SUMMARY

Embodiments of the present disclosure propose a method and apparatus for determining an answer to a question, an electronic device, a computer readable storage medium, and a computer program product.

Some embodiments of the present disclosure provide a method for determining an answer to a question, including: splicing an acquired to-be-queried question with each candidate answer into each question-answer pair; performing reasoning operations of feature combination parameters on different granularity features of each question-answer pair at a preset number of steps in a horizontal direction based on recurrent characteristics of a recurrent neural network; determining feature combination weights of the different granularity features using multiple preset vertical reasoning layers at different reasoning focuses respectively, at each step of the reasoning operations in the horizontal direction, where the vertical reasoning layers are in serial connection to each other; obtaining a candidate answer feature corresponding to each question-answer pair, respectively, through a final step of the reasoning operations; and determining a target candidate answer matching the to-be-queried question based on a feature similarity between a question feature of the to-be-queried question and each candidate answer feature.

Some embodiments of the present disclosure provide an apparatus for determining an answer to a question, including: a question-answer splicing unit, configured to splice an acquired to-be-queried question with each candidate answer into each question-answer pair; a horizontal reasoning unit, configured to perform reasoning operations of feature combination parameters on different granularity features of each question-answer pair at a preset number of steps in a horizontal direction based on recurrent characteristics of a recurrent neural network; a vertical reasoning unit, configured to determine feature combination weights of the different granularity features using multiple preset vertical reasoning layers at different reasoning focuses respectively, at each step of the reasoning operations in the horizontal direction, where the vertical reasoning layers are in serial connection to each other; a candidate answer feature acquiring unit, configured to obtain a candidate answer feature corresponding to each question-answer pair, respectively, through a final step of the reasoning operations; and a target candidate answer determining unit, configured to determine a target candidate answer matching the to-be-queried question based on a feature similarity between a question feature of the to-be-queried question and each candidate answer feature.

Some embodiments of the present disclosure provide an electronic device including one or more processors; and a storage device in communication with one or more processor, wherein the storage device stores instructions executable by the one or more processor, to enable the one or more processor to perform the above method for determining an answer to a question.

Some embodiments of the present disclosure provide a non-transitory computer readable storage medium, storing a computer instruction, wherein the computer instruction when executed by a computer causes the computer to perform the above method for determining an answer to a question.

Some embodiments of the present disclosure provide a computer program product comprising a computer program, wherein the computer program, when executed by a processor, causes the processor to perform the above method for determining an answer to a question.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

Other features, objectives and advantages of the present disclosure will become more apparent from reading the detailed description of non-limiting embodiments made with reference to the following accompanying drawings:

FIG. 1 is an exemplary system architecture to which the present disclosure may be applied;

FIG. 2 is a flowchart of a method for determining an answer to a question provided by an embodiment of the present disclosure;

FIG. 3 is a flowchart of a method for constructing a preset number of vertical reasoning layers provided by an embodiment of the present disclosure;

FIG. 4 is a flowchart of a method for generating a word-level feature for a candidate answer provided by an embodiment of the present disclosure;

FIG. 5 is a structural block diagram of an apparatus for determining an answer to a question provided by an embodiment of the present disclosure; and

FIG. 6 is a schematic structural diagram of an electronic device suitable for performing the method for determining an answer to a question provided by an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description. It should be noted that the embodiments and features in the embodiments in the present disclosure may be combined with each other on a non-conflict basis.

In the technical solution of the present disclosure, the collection, storage, use, processing, transmission, provision and disclosure of user personal information involved are all in compliance with relevant laws and regulations, and do not violate public order and good customs.

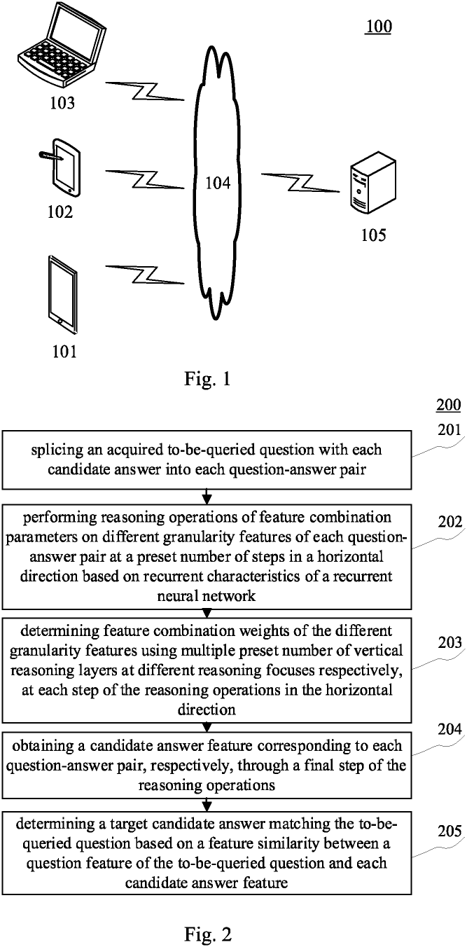

FIG. 1 shows an exemplary system architecture 100 to which embodiments of a method and apparatus for determining an answer to a question, an electronic device and a computer readable storage medium of the present disclosure may be applied.

As shown in FIG. 1, the system architecture 100 may include terminal devices 101, 102, 103, a network 104, and a server 105. The network 104 serves as a medium providing communication link between the terminal devices 101, 102, 103 and the server 105. The network 104 may include various types of connections, such as wired or wireless communication links, or optical cables.

Users may use the terminal devices 101, 102, 103 to interact with the server 105 via the network 104 to receive or send messages, etc. The terminal devices 101, 102, 103 and the server 105 may have various applications installed thereon for implementing information communication therebetween, such as knowledge Q&A applications, model training applications, or instant messaging applications.

The terminal devices 101, 102, and 103 may be hardware or software. When the terminal devices 101, 102, 103 are hardware, they may be various electronic devices having display screens, including but not limited to smart phones, tablet computers, laptops and desktop computers, etc. When the terminal devices 101, 102, and 103 are software, they may be installed in the electronic devices listed above, which may be implemented as multiple software or software modules, or as a single software or software module, which is not limited herein. When the server 105 is hardware, it may be implemented as a distributed server cluster composed of multiple servers or as a single server; when the server is software, it may be implemented as multiple software or software modules, or as a single software or software module, which is not limited herein.

The server 105 may provide various services through various built-in applications. Taking a knowledge Q&A application providing a service that provides answers corresponding to input questions as an example, the server 105 may achieve the following effects when running this knowledge Q&A application: first, receiving a to-be-queried question transmitted from the terminal devices 101, 102, and 103 via the network 104; then, splicing the to-be-queried question with each candidate answer into each question-answer pair; next, performing reasoning operations of feature combination parameters on different granularity features of each question-answer pair at a preset number of steps in a horizontal direction based on recurrent characteristics of a recurrent neural network; determining feature combination weights of the different granularity features using multiple preset vertical reasoning layers at different reasoning focuses respectively, at each step of the reasoning operations in the horizontal direction, where the vertical reasoning layers are in serial connection to each other; then, obtaining a candidate answer feature corresponding to each question-answer pair, respectively, through a final step of the reasoning operations; and finally, determining a target candidate answer matching the to-be-queried question based on a feature similarity between a question feature of the to-be-queried question and each candidate answer feature.

Further, the server 105 may also return the target candidate answer back to the terminal devices 101, 102, and 103 via the network 104.

It should be noted that the to-be-queried question may also be pre-stored locally on the server 105 by various means, in addition to being acquired from the terminal devices 101, 102, and 103 via the network 104. Therefore, when the server 105 detects that such data has been already stored locally (e.g., when starts to process a previously left to-be-processed question), it may choose to acquire such data directly locally, in which case the exemplary system architecture 100 may not include the terminal devices 101, 102, and 103, and the network 104.

Since retrieving a matching target candidate answer in a candidate knowledge base containing multiple candidate answers based on the to-be-queried question requires many computing resources and a strong computing power, the method for determining an answer to a question provided in subsequent embodiments of the present disclosure is generally performed by the server 105 having a strong computing power and many computing resources, and correspondingly, the apparatus for determining an answer to a question is also generally provided in the server 105. However, it should also be noted that when the terminal devices 101, 102, and 103 also have a computing power and computing resources meeting the requirements, the terminal devices 101, 102, and 103 may also use knowledge Q&A applications installed thereon to complete the various operations originally assigned to the server 105, then output identical results with the server 105. In particular, in the case where there are multiple terminal devices having different computing powers at the same time, but the knowledge Q&A applications determine that the terminal device has a strong computing power and many remaining computing resources, the terminal device may be allowed to perform the above operations, thus reducing computing pressure on the server 105 at a certain degree. Correspondingly, the apparatus for determining an answer to a question may also be provided in the terminal devices 101, 102, and 103. In this case, the exemplary system architecture 100 may also exclude the server 105 and the network 104.

It should be understood that the numbers of terminal devices, networks and servers in FIG. 1 are only illustrative. According to the implementation needs, there may be any number of terminal devices, networks and servers.

Referring to FIG. 2, FIG. 2 is a flowchart of a method for determining an answer to a question provided by an embodiment of the present disclosure, where a flow 200 includes the following steps 201 to 205.

Step 201: splicing an acquired to-be-queried question with each candidate answer into each question-answer pair.

This step aims to obtain each question-answer pair by an executing body of the method for determining an answer to a question (e.g., the server 105 shown in FIG. 1) by splicing the acquired to-be-queried question (e.g., extracted from a question query request initiated by the terminal devices 101, 102, and 103 shown in FIG. 1) with each candidate answer in a candidate answer base in the same domain. That is, each question-answer pair is obtained by splicing the to-be-queried question and a candidate answer, and the splicing may be performed by placing the question before the candidate answer, or placing the candidate answer after the question, as long as all the candidate answers are spliced with the question in the same splicing sequence.

The reason for the splicing of the to-be-queried question with the candidate answer is that by splicing the to-be-queried question with the candidate answer, they are fused together to jointly participate in subsequent feature reasoning, in order to better and more clearly determine an association degree between the two after the feature reasoning operations, in other words, to facilitate a subsequent step to determine a matching degree between the to-be-queried question and this candidate answer, i.e., whether this candidate answer is the answer to the to-be-queried question.

Step 202: performing reasoning operations of feature combination parameters on different granularity features of each question-answer pair at a preset number of steps in a horizontal direction based on recurrent characteristics of a recurrent neural network.

Based on step 201, this step aims to perform reasoning operations of feature combination parameters on different granularity features of each question-answer pair at a preset number of steps in a horizontal direction based on recurrent characteristics of a recurrent neural network by the executing body.

The different granularity features may include: a word-level feature, a sentence-level feature, and a full-content-level feature. The sentence-level feature is obtained by splicing the word-level features of words contained in a sentence in a sequence in which the words form the sentence, and the full-content-level feature is obtained by splicing sentence-level features of sentences contained in full question-answering content in a sequence in which the sentences form the full question-answering content. Full content consists of a question and an answer, usually containing multiple paragraphs or a long paragraph obtained by splicing together multiple original short paragraphs, containing multiple sentences.

That is, each time a cycle is performed, an iteration and update of model parameters are performed, in order to obtain a more accurate way of combining features through guidance from multiple cycles, i.e., a horizontal dynamic reasoning capability provided by a cycle mechanism is used to better process the multiple-granularity features of the question-answer pair in order to obtain a better feature representation.

In particular, the number of steps of the reasoning operations performed in the horizontal direction may be set in combination with corpus in an actual application scenario, a domain to which the corpus belongs, a complexity of the corpus and other factors that may affect a reasoning effect, which is not limited herein.

Step 203: determining feature combination weights of the different granularity features using multiple preset number of vertical reasoning layers at different reasoning focuses respectively, at each step of the reasoning operations in the horizontal direction.

Based on step 202, this step aims to determine the feature combination weights of the different granularity features using the multiple preset vertical reasoning layers at the different reasoning focuses respectively, at each step of the reasoning operations in the horizontal direction by the executing body. Each vertical reasoning layer corresponds to a different reasoning focus. For example, the reasoning focus may be a semantic consistency, a sequence consistency or a content overlap degree. By setting different reasoning focuses, different weight distributions for the different granularity features of the question-answer pair are available at each vertical reasoning layer, i.e., a magnitude of the weight of each granularity feature reflects an importance of that granularity feature at the reasoning focus. Moreover, depending on a serial connection structure among the multiple vertical reasoning layers, reasoning of an upper vertical reasoning layer may be obtained based on a reasoning result of a lower layer, i.e., the upper layer may “refer” to the reasoning result of the lower level for its own reasoning. It should be noted that the concepts of upper and lower layers are relative, not absolute.

Step 204: obtaining a candidate answer feature corresponding to each question-answer pair, respectively, through a final step of the reasoning operations;

Based on step 202 and step 203, this step aims to obtain the candidate answer feature corresponding to each question-answer pair, respectively, through the final step of the reasoning operations by the executing body. That is, during each step of the horizontal reasoning operations, the vertical reasoning solution provided in step 203 is followed, so that a result of the uppermost vertical reasoning layer in a horizontal reasoning step may be used as a horizontal reasoning result of this step, and a horizontal reasoning result of this step may be used as an input to the horizontal reasoning operation of the next step, followed by the vertical reasoning step provided in step 203, and finally the candidate answer feature corresponding to each question-answer pair may be obtained, through the final step of the reasoning operations.

It should be noted that the reason why an output of each input question-answer pair here is referred to as the corresponding candidate answer feature is that the present disclosure here needs to reflect feature differences between the different answers for feature comparison with the question feature of the to-be-queried question.

Step 205: determining a target candidate answer matching the to-be-queried question based on a feature similarity between a question feature of the to-be-queried question and each candidate answer feature.

Based on step 204, this step aims to determine the target candidate answer matching the to-be-queried question based on the feature similarity between the question feature of the to-be-queried question and each candidate answer feature by the executing body.

An implementation may include but not limited to:

first, calculating an actual feature similarity between the question feature and each candidate answer feature, respectively; then, determining a candidate answer feature having an actual feature similarity greater than a preset similarity as a target candidate answer feature; and finally determining a candidate answer corresponding to the target candidate answer feature as the target candidate answer matching the to-be-queried question.

It should be noted that a magnitude of the preset similarity may be obtained by performing summarization based on historical experiments, or a similarity value of the K^{th} similarity by ranking similarities according to the actual feature similarity may be used as the preset similarity to achieve the effect of selecting the TOP K candidate answers, or the actual feature similarity of a last candidate answer feature corresponding to the top N% candidate answer features may be used as the preset similarity to achieve the effect of selecting the top N% candidate answers.

The method for determining an answer to a question provided by embodiments of the present disclosure, based on a horizontal reasoning mechanism provided by recurrent characteristics of a recurrent neural network, additionally extracts question-answer pairs, each composed of a question and an answer, into features of different granularity levels, and introduces the concept of vertical dynamic hierarchical reasoning, sets multiple vertical reasoning layers for reflecting different reasoning focuses, and controls that features of different granularity levels at each reasoning focus will dynamically have corresponding feature combination weights, so that candidate answer features of different granularities can be better fused. Therefore, based on the feature similarity between the question feature and the candidate answer feature, a target candidate answer that better matches the to-be-queried question can be selected.

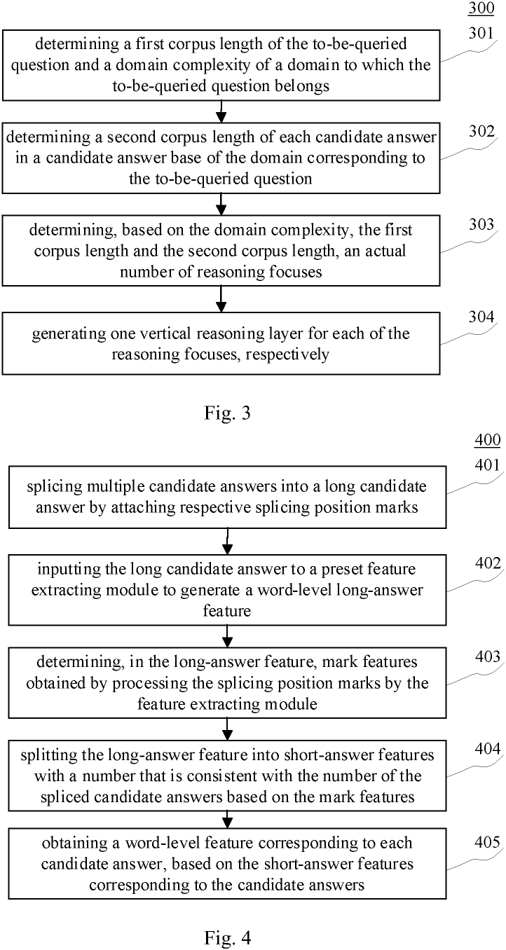

To deepen the understanding of how to obtain the vertical reasoning layers specifically and how to determine an appropriate number of the vertical reasoning layers, the present disclosure also illustrates, by way of FIG. 3, a flowchart of a method for constructing a preset number of vertical reasoning layers, where a flow 300 includes the following steps 301 to 304.

Step 301: determining a first corpus length of the to-be-queried question and a domain complexity of a domain to which the to-be-queried question belongs;

This step aims to determine the corpus length of the to-be-queried question as the first corpus length, and the domain complexity of the domain to which the to-be-queried question belongs by an executing body (which may still be the executing body of the embodiment shown in FIG. 2, or may be replaced by another server distinct from the server 105 shown in FIG. 1).

It should be understood that, typically, a longer corpus length of a question means that describing the question clearly needs to contain more limiting factors and specific contents. A higher domain complexity of the domain to which a question belongs means that the reasoning is more difficult and the question is more complex.

For example, Q&A in a medical domain is significantly more complex than Q&A in a song domain, and question stems in the medical domain need to contain more content and knowledge, as do those in physics, which require more advanced mathematics or for other domains with complex knowledge.

Step 302: determining a second corpus length of each candidate answer in a candidate answer base of the domain corresponding to the to-be-queried question;

Based on step 301, this step aims to determine the second corpus length of each candidate answer in the candidate answer base of the domain corresponding to the to-be-queried question by the executing body. That is, the second corpus length may be specified as an average of corpus lengths of multiple candidate answers, and may be used as the second corpus length distinguished from the first corpus length.

Step 303: determining, based on the domain complexity, the first corpus length and the second corpus length, an actual number of reasoning focuses;

Based on step 302, this step aims to determine the actual number of reasoning focuses that should be available at the moment, based on the domain complexity, the first corpus length and the second corpus length by the executing body. That is, typically, the higher the domain complexity, the greater the corpus length, the more likely more content contained in. Therefore, more reasoning focuses should be set. In addition, the number of reasoning focuses may be further combined with customized points of consideration in this domain in an actual application scenario, enabling the actual number finally determined to be more in line with practical needs.

Step 304: generating one vertical reasoning layer for each of the reasoning focuses, respectively.

Based on step 303, this step aims to generate one vertical reasoning layer for each of the reasoning focuses, respectively, by the executing body, to finally obtain an actual number of vertical reasoning layers.

This embodiment provides a generation solution for vertical reasoning layers through steps 301-304, based on the corpus lengths of the to-be-queried question and the candidate answers in the same domain, and the domain complexity of the domain to which the question and answers belong, jointly determines the actual number of required reasoning focuses, and finally generates a corresponding vertical reasoning layer based on each reasoning focus, so that the generated vertical reasoning layers better match actual questions and a matching degree between the matched target candidate answer and the to-be-queried question can be finally improved.

The above solution needs to use features of different granularities, and the different features of granularities need to be based on the word-level feature. It is also considered that the word-level feature of each candidate answer or each question-answer pair is generated correspondingly, that is, in a case that a candidate answer or a question-answer pair is input into a feature extraction model, the corresponding word-level feature is output. Therefore, as many candidate answers or question-answer pairs as there are, as many times of inputs to the feature extraction model there are, which is troublesome.

To address this issue, in order to simplify the number of inputs as much as possible and improve an efficiency of acquiring the word-level feature, this embodiment also illustrates, by way of FIG. 4, a flowchart of a method for generating a word-level feature for a candidate answer, where a flow 400 includes the following steps 401 to 405.

Step 401: splicing multiple candidate answers into a long candidate answer by attaching respective splicing position marks;

That is, this step aims to splice the multiple candidate answers into the long candidate answer, and in the process of splicing, attach a splicing position mark to indicate a splicing position of each candidate answer by an executing body (which may be still by the executing body of the embodiment shown in FIG. 2, or may be replaced by another server distinct from the server 105 shown in FIG. 1).

Step 402: inputting the long candidate answer to a preset feature extracting module to generate a word-level long-answer feature;

Based on step 401, this step aims to input the long candidate answer to the preset feature extracting module to generate the word-level long-answer feature by the executing body. That is, the long-answer feature corresponds to the long candidate answer obtained from splicing, which contains not only the word-level feature of each candidate answer, but also a new representation of the splicing position marks (because of processing by the feature extracting module, the representation of mark is changed).

Step 403: determining, in the long-answer feature, mark features obtained by processing the splicing position marks by the feature extracting module;

Based on step 402, this step aims to determine, in the long answer feature, the mark features obtained by processing the splicing position marks by the feature extracting module by the executing body.

Step 404: splitting the long-answer feature into short-answer features with a number that is consistent with the number of the spliced candidate answers based on the mark features;

Based on step 403, this step aims to accurately indicate how to split from the long-answer feature based on the determined mark features, so as to perform splitting to obtain the short-answer features with a number that is consistent with the number of the spliced candidate answers by the executing body.

Step 405: obtaining a word-level feature corresponding to each candidate answer, based on the short-answer features corresponding to the candidate answers.

Based on step 404, this step aims to obtain the word-level feature corresponding to each candidate answer, based on the short-answer features corresponding to the candidate answers by the executing body.

In particular, the splicing position marks may be embodied and implemented by the masking technology.

For better understanding, the present disclosure also illustrates a knowledge Q&A scenario in the medical domain as an example, where a pre-constructed answer query model is used to return an answer matching an input medical question.

The answer query model contains a question-answer splicing module, a feature extracting module, a horizontal reasoning module, a vertical reasoning module, and a feature matching module.

The complete process is as follows:
splicing an acquired to-be-queried question with each candidate answer into each question-answer pair using the preset question-answer splicing module;
obtaining different granularity features of each question-answer pair using the preset feature extracting module;
performing reasoning operations of feature combination parameters on the different granularity features at a preset number of steps in a horizontal direction using the preset horizontal reasoning module, where the reasoning operations provided by the horizontal reasoning module are constructed based on recurrent characteristics of a recurrent neural network;
determining feature combination weights of the different granularity features at multiple preset vertical reasoning layers respectively using the preset vertical reasoning module, at each step of the reasoning operations in the horizontal direction, where the different vertical reasoning layers correspond to different reasoning focuses;
outputting, by the horizontal reasoning module, a candidate answer feature corresponding to each question-answer pair, respectively;
obtaining a question feature of the to-be-queried question using the preset feature extracting module; and
calculating a feature similarity between the question feature and each candidate answer feature based on the preset feature matching module, and outputting a target candidate answer matching the to-be-queried question based on the feature similarity.

It should be noted that, unlike other domains or scenarios containing complex knowledge, in the medical knowledge domain, the to-be-queried question is usually represented as a combination of a to-be-queried medical question and candidate options, and the candidate answers are usually represented as multiple pieces of medical knowledge evidence. Therefore, the matching according to the above solution actually determines which of the candidate options best matches a stem of the medical question by combining the medical knowledge evidence. That is, using the above model, it may be determined which of the multiple candidate options provided under the medical question is the most correct. In other scenarios, it is usually only represented as the stem of the question plus the candidate answers.

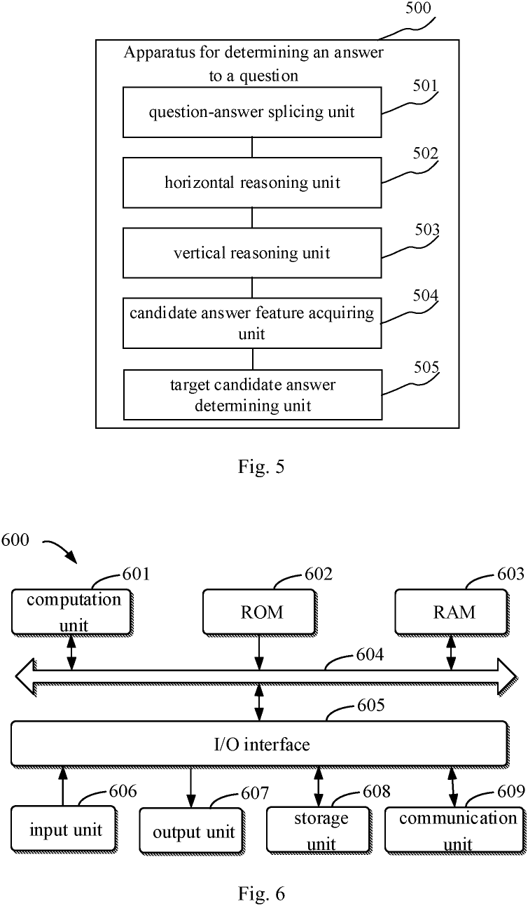

With further reference to FIG. 5, as an implementation of the method shown in the above figures, the present disclosure provides an embodiment of an apparatus for determining an answer to a question, and the embodiment of the apparatus corresponds to the embodiment of the method shown in FIG. 2. The apparatuses may be applied to various electronic devices.

As shown in FIG. 5, the apparatus 500 for determining an answer to a question may include: a question-answer splicing unit 501, a horizontal reasoning unit 502, a vertical reasoning unit 503, a candidate answer feature acquiring unit 504, a target candidate answer determining unit 505. The question-answer splicing unit 501 is configured to splice an acquired to-be-queried question with each candidate answer into each question-answer pair. The horizontal reasoning unit 502 is configured to perform reasoning operations of feature combination parameters on different granularity features of each question-answer pair at a preset number of steps in a horizontal direction based on recurrent characteristics of a recurrent neural network. The vertical reasoning unit 503 is configured to determine feature combination weights of the different granularity features using multiple preset vertical reasoning layers at different reasoning focuses respectively, at each step of the reasoning operations in the horizontal direction, where, the vertical reasoning layers are in serial connection to each other. The candidate answer feature acquiring unit 504 is configured to obtain a candidate answer feature corresponding to each question-answer pair, respectively, through a final step of the reasoning operations. The target candidate answer determining unit 505 is configured to determine a target candidate answer matching the to-be-queried question based on a feature similarity between a question feature of the to-be-queried question and each candidate answer feature.

In this embodiment, in the apparatus 500 for determining an answer to a question, for the specific processing and technical effects of the question-answer splicing unit 501, the horizontal reasoning unit 502, the vertical reasoning unit 503, the candidate answer feature acquiring unit 504, the target candidate answer determining unit 505, reference may be made to the relevant descriptions of steps 201-203 in the corresponding embodiment of FIG. 2, and detailed description thereof will be omitted.

In some alternative implementations of this embodiment, the different granularity features comprise: a word-level feature, a sentence-level feature, and a full content-level feature, the sentence feature is obtained by splicing the word-level features of words contained in a sentence in a sequence in which the words form the sentence, and the full content-level feature are obtained by splicing sentence-level features of sentences contained in full question-answering content in a sequence in which the sentences form the full question-answering content.

In some alternative implementations of this embodiment, the apparatus 500 for determining an answer to a question may further include: a vertical reasoning layer constructing unit configured to pre-construct a preset number of vertical reasoning layers, where the vertical reasoning layer constructing unit is further configured to:
determine a first corpus length of the to-be-queried question and a domain complexity of a domain to which the to-be-queried question belongs;
determine a second corpus length of each candidate answer in a candidate answer base of the domain corresponding to the to-be-queried question;
determine, based on the domain complexity, the first corpus length and the second corpus length, an actual number of reasoning focuses; and
generate one vertical reasoning layers for each reasoning focuses, respectively.

In some alternative implementations of this embodiment, the target candidate answer determining unit 505 may be further configured to:
calculate an actual feature similarity between the question feature and each candidate answer feature, respectively;
determine a candidate answer feature having the actual feature similarity greater than a preset similarity as the target candidate answer feature; and
determine a candidate answer corresponding to the target candidate answer feature as the target candidate answer matching the to-be-queried question.

In some alternative implementations of this embodiment, the apparatus 500 for determining an answer to a question may further include: an word-level feature generating unit configured to generate a word-level feature for a candidate answer, where the word-level feature generating unit is further configured to:
splice multiple candidate answers into a long candidate answer by attaching respective splicing position marks;
input the long candidate answer to a preset feature extracting module to generate a word-level long-answer feature;
determine, in the long-answer feature, mark features obtained by processing the splicing position marks by the feature extracting module;
split the long-answer feature into short-answer features with a number that is consistent with the number of the spliced candidate answers based on the mark features; and
obtain a word-level feature corresponding to each candidate answer, based on the short-answer features corresponding to the candidate answers.

In some alternative implementations of this embodiment, in response to the to-be-queried question belonging to a medical knowledge domain, the to-be-queried question includes: a combination of a to-be-queried medical question and candidate options, and the candidate answers include: medical knowledge evidences.

In some alternative implementations of this embodiment, the horizontal reasoning unit 502 may be further configured to:
obtain the different granularity features of each question-answer pair using the preset feature extracting module;
perform reasoning operations of feature combination parameters on different granularity features of each question-answer pair at a preset number of steps in a horizontal direction using a preset horizontal reasoning module, where the reasoning operations provided by the horizontal reasoning module are constructed based on the recurrent characteristics of the recurrent neural network;
correspondingly, the vertical reasoning unit 503 may be further configured to:
determine the feature combination weights of the different granularity features using multiple preset vertical reasoning layers at different reasoning focuses respectively using a preset vertical reasoning module, at each step of the reasoning operations in the horizontal direction, where the different vertical reasoning layers correspond to different reasoning focuses;
correspondingly, the candidate answer feature acquiring unit 504 may be further configured to:
output, by the horizontal reasoning module, the candidate answer feature corresponding to each question-answer pair, respectively;
correspondingly, the target candidate answer determining unit 505 may be further configured to:
obtain the question feature of the to-be-queried question using the preset feature extracting module; and
calculate the feature similarity between the question feature and each candidate answer feature based on a preset feature matching module, and output the target candidate answer matching the to-be-queried question based on the feature similarity;
where, the feature extracting module, the horizontal reasoning module, the vertical reasoning module, and the feature matching module are all used as parts forming a preset answer query model.

This embodiment exists as the apparatus embodiment corresponding to the method embodiment described above. The apparatus for determining an answer to a question provided by this embodiment, based on a horizontal reasoning mechanism provided by recurrent characteristics of a recurrent neural network, additionally extracts question-answer pairs, each composed of a question and an answer, into features of different granularity levels, and introduces the concept of vertical dynamic hierarchical reasoning, sets multiple vertical reasoning layers for reflecting different reasoning focuses, and controls that features of different granularity levels at each reasoning focus will dynamically have corresponding feature combination weights, so that candidate answer features of different granularities can be better fused. Therefore, based on the feature similarity between the question feature and the candidate answer feature, a target candidate answer that better matches the to-be-queried question can be selected.

According to an embodiment of the present disclosure, the present disclosure also provides an electronic device, including: at least one processor; and a memory communicatively connected to the at least one processor; where, the memory stores instructions executable by the at least one processor, and the instructions, when executed by the at least one processor, cause the at least one processor to perform the method for determining an answer to a question described in any one of the above embodiments.

According to an embodiment of the present disclosure, the present disclosure also provides a readable storage medium storing computer instructions, where, the computer instructions are used to cause the computer to implement the method for determining an answer to a question described in any one of the above embodiments.

According to an embodiment of the present disclosure, the present disclosure also provides a computer program product, the computer program, when executed by a processor, implements the method for determining an answer to a question described in any one of the above embodiments.

FIG. 6 shows a schematic block diagram of an example electronic device 600 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The parts shown herein, their connections and relationships, and their functions are merely examples, and are not intended to limit the implementation of the present disclosure described and/or claimed herein.

As shown in FIG. 6, the device 600 includes a computation unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computation unit 601, the ROM 602, and the RAM 603 are connected to each other through a bus 604. An input/output (I/O) interface 605 is also connected to the bus 604.

A plurality of parts in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 609, for example, a network card, a modem, or a wireless communication transceiver. The communication unit 609 allows the device 600 to exchange information/data with other devices over a computer network such as the Internet and/or various telecommunication networks.

The computation unit 601 may be various general-purpose and/or dedicated processing components having processing and computing capabilities. Some examples of the computation unit 601 include, but are not limited to, central processing unit (CPU), graphics processing unit (GPU), various dedicated artificial intelligence (AI) computing chips, various computation units running machine learning model algorithms, digital signal processors (DSP), and any appropriate processors, controllers, microcontrollers, etc. The computation unit 601 performs the various methods and processes described above, such as the method for determining an answer to a question. For example, in some embodiments, the method for determining an answer to a question may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computation unit 601, one or more steps of the method for determining an answer to a question may be performed. Alternatively, in other embodiments, the computation unit 601 may be configured to perform the method for determining an answer to a question by any other appropriate means (for example, by means of firmware).

Various embodiments of the systems and technologies described above in this paper can be implemented in digital electronic circuit systems, integrated circuit systems, field programmable gate arrays (FPGAs), application specific integrated circuits (ASIC), application specific standard products (ASSP), system on chip (SOC), load programmable logic devices (CPLD), computer hardware, firmware, software, and/or combinations thereof. These various embodiments may include: being implemented in one or more computer programs, the one or more computer programs can be executed and/or interpreted on a programmable system including at least one programmable processor, which can be a special-purpose or general-purpose programmable processor, and can receive data and instructions from the storage system, at least one input device, and at least one output device, and transmitting data and instructions to the storage system, the at least one input device, and the at least one output device.

The program code for implementing the methods of the present disclosure may be written in any combination of one or more programming languages. These program codes can be provided to the processor or controller of general-purpose computer, special-purpose computer or other programmable data processing device, so that when the program code is executed by the processor or controller, the functions/operations specified in the flow chart and/or block diagram are implemented. The program code can be completely executed on the machine, partially executed on the machine, partially executed on the machine and partially executed on the remote machine as a separate software package, or completely executed on the remote machine or server.

In the context of the present disclosure, a machine-readable medium may be a tangible medium that may contain or store a program for use by or in combination with an instruction execution system, apparatus, or device. The machine-readable medium can be a machine-readable signal medium or a machine-readable storage medium. Machine readable media may include, but are not limited to, electronic, magnetic, optical, electromagnetic, infrared, or semiconductor systems, apparatuses, or devices, or any suitable combination of the foregoing. More specific examples of machine-readable storage media may include one or more wire based electrical connections, portable computer disks, hard disks, random access memory (RAM), read only memory (ROM), erasable programmable read only memory (EPROM or flash memory), optical fibers, compact disk read only memory (CD-ROM), optical storage devices, magnetic storage devices, or any suitable combination of the above.

In order to provide interaction with users, the systems and techniques described herein can be implemented on a computer with: a display device for displaying information to users (for example, a CRT (cathode ray tube) or LCD (liquid crystal display) monitor); and a keyboard and a pointing device (e.g., a mouse or a trackball) through which the user can provide input to the computer. Other kinds of devices can also be used to provide interaction with users. For example, the feedback provided to the user may be any form of sensor feedback (e.g., visual feedback, auditory feedback, or tactile feedback); and the input from the user can be received in any form (including acoustic input, voice input or tactile input).

The systems and techniques described herein may be implemented in a computing system including background components (e.g., as a data server), or a computing system including middleware components (e.g., an application server) or a computing system including a front-end component (e.g., a user computer with a graphical user interface or a web browser through which a user can interact with embodiments of the systems and techniques described herein), or a computing system including any combination of the back-end component, the middleware component, the front-end component. The components of the system can be interconnected by digital data communication (e.g., communication network) in any form or medium. Examples of communication networks include local area networks (LANs), wide area networks (WANs), and the Internet.

A computer system may include a client and a server. The client and the server are generally far away from each other and usually interact through communication networks. The relationship between the client and the server is generated by computer programs running on the corresponding computers and having a client server relationship with each other. The server can be a cloud server, which is a host product in the cloud computing service system to solve the defects of the traditional physical host and virtual private server (VPS, Virtual Private Server) services, such as high management difficulty and weak business scalability.

The technical solution of the embodiments of the present disclosure, based on a horizontal reasoning mechanism provided by the recurrent characteristics of the recurrent neural network, additionally extracts question-answer pairs composed of a question and answers into features of different granularity levels, and introduces the concept of vertical dynamic hierarchical reasoning, sets multiple vertical reasoning layers for reflecting different reasoning focuses, and controls that features of different levels of granularity at each reasoning focus will dynamically have corresponding feature combination weights, so that candidate answer features of different granularity can be better fused, so that based on the feature similarity between the question features and the candidate answer features, a target candidate answer that better matches the to-be-queried question may be selected.

It should be understood that various forms of processes shown above can be used to reorder, add or delete steps. For example, the steps recorded in the present disclosure can be performed in parallel, in sequence, or in different orders, as long as the desired results of the technical solution of the present disclosure can be achieved, which is not limited herein.

The above specific embodiments do not constitute restrictions on the scope of the present disclosure. Those skilled in the art should understand that various modifications, combinations, sub combinations and substitutions can be made according to design requirements and other factors. Any modification, equivalent replacement and improvement made within the spirit and principles of this disclosure shall be included in the scope of protection of this disclosure.

What is claimed is:

1. A method for determining an answer to a question, the method comprising:
splicing an acquired to-be-queried question with each candidate answer into each question-answer pair;
performing reasoning operations of feature combination parameters on different granularity features of each question-answer pair at a preset number of steps in a horizontal direction based on recurrent characteristics of a recurrent neural network;
determining feature combination weights of the different granularity features using multiple preset vertical reasoning layers at different reasoning focuses respectively, at each step of the reasoning operations in the horizontal direction, wherein the vertical reasoning layers are in serial connection to each other;
obtaining a candidate answer feature corresponding to each question-answer pair, respectively, through a final step of the reasoning operations; and
determining a target candidate answer matching the to-be-queried question based on a feature similarity between a question feature of the to-be-queried question and each candidate answer feature.

2. The method according to claim 1, wherein the different granularity features comprise: a word-level feature, a sentence-level feature, and a full content-level feature, the sentence-level feature is obtained by splicing the word-level features of words contained in a sentence in a sequence in which the words form the sentence, and the full content-level feature are obtained by splicing sentence-level features of sentences contained in full question-answering content in a sequence in which the sentences form the full question-answering content.

3. The method according to claim 1, wherein the method further comprises: pre-constructing a preset number of vertical reasoning layers, wherein the pre-constructing a preset number of vertical reasoning layers, comprises:
determining a first corpus length of the to-be-queried question and a domain complexity of a domain to which the to-be-queried question belongs;
determining a second corpus length of each candidate answer in a candidate answer base of the domain corresponding to the to-be-queried question;
determining, based on the domain complexity, the first corpus length and the second corpus length, an actual number of reasoning focuses; and
generating one vertical reasoning layers for each reasoning focuses, respectively.

4. The method according to claim 1, wherein determining a target candidate answer matching the to-be-queried question based on the feature similarity between the question feature of the to-be-queried question and the candidate answer feature, comprises:
calculating an actual feature similarity between the question feature and each candidate answer feature, respectively;
determining a candidate answer feature having the actual feature similarity greater than a preset similarity as the target candidate answer feature; and
determining a candidate answer corresponding to the target candidate answer feature as the target candidate answer matching the to-be-queried question.

5. The method according to claim 2, wherein the method further comprises: generating a word-level feature for a candidate answer, wherein generating the word-level feature for the candidate answer, comprises:
splicing multiple candidate answers into a long candidate answer by attaching respective splicing position marks;
inputting the long candidate answer to a preset feature extracting module to generate a word-level long-answer feature;
determining, in the word-level long-answer feature, mark features obtained by processing the splicing position marks by the feature extracting module;
splitting the word-level long-answer feature into short-answer features with a number that is consistent with the number of the spliced candidate answers based on the mark features; and
obtaining a word-level feature corresponding to each candidate answer, based on the short-answer features corresponding to the candidate answers.

6. The method according to claim 1, wherein in response to the to-be-queried question belonging to a medical knowledge domain, the to-be-queried question comprises:
a combination of a to-be-queried medical question and candidate options, and the candidate answers comprise:
medical knowledge evidences.

7. The method according to claim 5, wherein performing reasoning operations of feature combination parameters on different granularity features of each question-answer pair at a preset number of steps in a horizontal direction based on recurrent characteristics of a recurrent neural network, comprises:
obtaining the different granularity features of each question-answer pair using the preset feature extracting module;
performing reasoning operations of feature combination parameters on different granularity features of each question-answer pair at a preset number of steps in a horizontal direction using a preset horizontal reasoning module, wherein the reasoning operations provided by the preset horizontal reasoning module are constructed based on the recurrent characteristics of the recurrent neural network;
correspondingly, determining feature combination weights of the different granularity features using multiple preset vertical reasoning layers at different reasoning focuses respectively, at each step of the reasoning operations in the horizontal direction, comprises:
determining the feature combination weights of the different granularity features using multiple preset vertical reasoning layers at different reasoning focuses respectively using a preset vertical reasoning module, at each step of the reasoning operations in the horizontal direction, wherein the different vertical reasoning layers correspond to different reasoning focuses;
correspondingly, obtaining a candidate answer feature corresponding to each question-answer pair, respectively, through a final step of the reasoning operations, comprises:
outputting, by the preset horizontal reasoning module, the candidate answer feature corresponding to each question-answer pair, respectively;
correspondingly, determining a target candidate answer matching the to-be-queried question based on a feature similarity between the question feature of the to-be-queried question and each candidate answer feature, comprises:
obtaining the question feature of the to-be-queried question using the preset feature extracting module; and
calculating the feature similarity between the question feature and each candidate answer feature based on a preset feature matching module, and outputting the target candidate answer matching the to-be-queried question based on the feature similarity,
wherein, the feature extracting module, the preset horizontal reasoning module, the preset vertical reasoning module, and the feature matching module are all used as parts forming a preset answer query model.

8. An apparatus for determining an answer to a question, the apparatus comprising:
at least one processor; and
a memory storing instructions, wherein the instructions when executed by the at least one processor, cause the at least one processor to perform operations, the operations comprising:
splicing an acquired to-be-queried question with each candidate answer into each question-answer pair;
performing reasoning operations of feature combination parameters on different granularity features of each question-answer pair at a preset number of steps in a horizontal direction based on recurrent characteristics of a recurrent neural network;
determining feature combination weights of the different granularity features using multiple preset vertical reasoning layers at different reasoning focuses respectively, at each step of the reasoning operations in the horizontal direction, wherein the vertical reasoning layers are in serial connection to each other;
obtaining a candidate answer feature corresponding to each question-answer pair, respectively, through a final step of the reasoning operations; and
determining a target candidate answer matching the to-be-queried question based on a feature similarity between a question feature of the to-be-queried question and each candidate answer feature.

9. The apparatus according to claim 8, wherein the different granularity features comprise: a word-level feature, a sentence-level feature, and a full content-level feature, the sentence-level feature is obtained by splicing the word-level features of words contained in a sentence in a sequence in which the words form the sentence, and the full content-level feature are obtained by splicing sentence-level features of sentences contained in full question-answering content in a sequence in which the sentences form the full question-answering content.

10. The apparatus according to claim 8, wherein the operations further comprise: pre-constructing a preset number of vertical reasoning layers, wherein the pre-constructing a preset number of vertical reasoning layers, comprises:
determining a first corpus length of the to-be-queried question and a domain complexity of a domain to which the to-be-queried question belongs;
determining a second corpus length of each candidate answer in a candidate answer base of the domain corresponding to the to-be-queried question;
determining, based on the domain complexity, the first corpus length and the second corpus length, an actual number of reasoning focuses; and
generating one vertical reasoning layers for each reasoning focuses, respectively.

11. The apparatus according to claim 8, wherein determining a target candidate answer matching the to-be-queried question based on the feature similarity between the question feature of the to-be-queried question and the candidate answer feature, comprises:
calculating an actual feature similarity between the question feature and each candidate answer feature, respectively;
determining a candidate answer feature having the actual feature similarity greater than a preset similarity as the target candidate answer feature; and
determining a candidate answer corresponding to the target candidate answer feature as the target candidate answer matching the to-be-queried question.

12. The apparatus according to claim 9, wherein the operations further comprise: generating a word-level feature for a candidate answer, wherein generating the word-level feature for the candidate answer, comprises:
splicing multiple candidate answers into a long candidate answer by attaching respective splicing position marks;
inputting the long candidate answer to a preset feature extracting module to generate a word-level long-answer feature;
determining, in the word-level long-answer feature, mark features obtained by processing the splicing position marks by the feature extracting module;
splitting the word-level long-answer feature into short-answer features with a number that is consistent with the number of the spliced candidate answers based on the mark features; and
obtaining a word-level feature corresponding to each candidate answer, based on the short-answer features corresponding to the candidate answers.

13. The apparatus according to claim 8, wherein in response to the to-be-queried question belonging to a medical knowledge domain, the to-be-queried question comprises:
a combination of a to-be-queried medical question and candidate options, and the candidate answers comprise:
medical knowledge evidences.

14. The apparatus according to claim 12, wherein performing reasoning operations of feature combination parameters on different granularity features of each question-answer pair at a preset number of steps in a horizontal direction based on recurrent characteristics of a recurrent neural network, comprises:
obtaining the different granularity features of each question-answer pair using the preset feature extracting module;
performing reasoning operations of feature combination parameters on different granularity features of each question-answer pair at a preset number of steps in a horizontal direction using a preset horizontal reasoning module, wherein the reasoning operations provided by the preset horizontal reasoning module are constructed based on the recurrent characteristics of the recurrent neural network;
correspondingly, determining feature combination weights of the different granularity features using multiple preset vertical reasoning layers at different reasoning focuses respectively, at each step of the reasoning operations in the horizontal direction, comprises:
determining the feature combination weights of the different granularity features using multiple preset vertical reasoning layers at different reasoning focuses respectively using a preset vertical reasoning module, at each step of the reasoning operations in the horizontal direction, wherein the different vertical reasoning layers correspond to different reasoning focuses;
correspondingly, obtaining a candidate answer feature corresponding to each question-answer pair, respectively, through a final step of the reasoning operations, comprises:
outputting, by the preset horizontal reasoning module, the candidate answer feature corresponding to each question-answer pair, respectively;
correspondingly, determining a target candidate answer matching the to-be-queried question based on a feature similarity between the question feature of the to-be-queried question and each candidate answer feature, comprises:
obtaining the question feature of the to-be-queried question using the preset feature extracting module; and
calculating the feature similarity between the question feature and each candidate answer feature based on a preset feature matching module, and outputting the target candidate answer matching the to-be-queried question based on the feature similarity;
wherein, the feature extracting module, the preset horizontal reasoning module, the preset vertical reasoning module, and the feature matching module are all used as parts forming a preset answer query model.

15. A non-transitory computer readable storage medium storing computer instructions, wherein, the computer instructions are used to cause the computer to perform operations comprising:
splicing an acquired to-be-queried question with each candidate answer into each question-answer pair;
performing reasoning operations of feature combination parameters on different granularity features of each question-answer pair at a preset number of steps in a horizontal direction based on recurrent characteristics of a recurrent neural network;
determining feature combination weights of the different granularity features using multiple preset vertical reasoning layers at different reasoning focuses respectively, at each step of the reasoning operations in the horizontal direction, wherein the vertical reasoning layers are in serial connection to each other;
obtaining a candidate answer feature corresponding to each question-answer pair, respectively, through a final step of the reasoning operations; and
determining a target candidate answer matching the to-be-queried question based on a feature similarity between a question feature of the to-be-queried question and each candidate answer feature.

16. The non-transitory computer readable storage medium according to claim 15, wherein the different granularity features comprise: a word-level feature, a sentence-level feature, and a full content-level feature, the sentence-level feature is obtained by splicing the word-level features of words contained in a sentence in a sequence in which the words form the sentence, and the full content-level feature are obtained by splicing sentence-level features of sentences contained in full question-answering content in a sequence in which the sentences form the full question-answering content.

17. The non-transitory computer readable storage medium according to claim 15, wherein the operations further comprise: pre-constructing a preset number of vertical reasoning layers, wherein the pre-constructing a preset number of vertical reasoning layers, comprises:
determining a first corpus length of the to-be-queried question and a domain complexity of a domain to which the to-be-queried question belongs;
determining a second corpus length of each candidate answer in a candidate answer base of the domain corresponding to the to-be-queried question;
determining, based on the domain complexity, the first corpus length and the second corpus length, an actual number of reasoning focuses; and
generating one vertical reasoning layers for each reasoning focuses, respectively.

18. The non-transitory computer readable storage medium according to claim 15, wherein determining a target candidate answer matching the to-be-queried question based on the feature similarity between the question feature of the to-be-queried question and the candidate answer feature, comprises:
calculating an actual feature similarity between the question feature and each candidate answer feature, respectively;
determining a candidate answer feature having the actual feature similarity greater than a preset similarity as the target candidate answer feature; and
determining a candidate answer corresponding to the target candidate answer feature as the target candidate answer matching the to-be-queried question.

19. The non-transitory computer readable storage medium according to claim 16, wherein the operations further comprise: generating a word-level feature for a candidate answer, wherein generating the word-level feature for the candidate answer, comprises:
splicing multiple candidate answers into a long candidate answer by attaching respective splicing position marks;
inputting the long candidate answer to a preset feature extracting module to generate a word-level long-answer feature;
determining, in the word-level long-answer feature, mark features obtained by processing the splicing position marks by the feature extracting module;
splitting the word-level long-answer feature into short-answer features with a number that is consistent with the number of the spliced candidate answers based on the mark features; and
obtaining a word-level feature corresponding to each candidate answer, based on the short-answer features corresponding to the candidate answers.

20. The non-transitory computer readable storage medium according to claim 15, wherein in response to the to-be-queried question belonging to a medical knowledge domain, the to-be-queried question comprises: a combination of a to-be-queried medical question and candidate options, and the candidate answers comprise: medical knowledge evidences.
